(19) United States
(12) Patent Application Publication
(10) Pub. No.: US 2015/0153044 A1
(43) Pub. Date: Jun. 4, 2015

(54) TURBOMACHINE COMBUSTOR ASSEMBLY

(71) Applicant: General Electric Company, Schenectady, NE (US)

(72) Inventors: Ilya Aleksandrovich Slobodyanskiy, Simpsonville, SC (US); Alexander Nikolay Sokolov, Moscow (RU); Dimitry Vladlenovich Tretyakov, Moscow (RU)

(21) Appl. No.: 14/388,573

(22) PCT Filed: Mar. 29, 2012
(86) PCT No.: PCT/RU12/00232

§ 371 Date: Sep. 26, 2014

(51) Int. Cl. F23R 3/04; F02C 7/18; F02C 3/04

(52) U.S. Cl. CPC F23R 3/04; F02C 3/04; F02C 7/18; F23R 2900/03041; F05D 2240/35

(57) ABSTRACT

A turbomachine combustor assembly includes a combustor body, and a combustor liner arranged within the combustor body. The combustor liner defines a combustion chamber having a head end and a discharge end. A plurality of combustor nozzles are arranged in an annular array at the head end of the combustion chamber, and a fluid delivery nozzle is arranged substantially centrally within the annular array at the head end of the combustion chamber. The fluid delivery nozzle includes a first end portion that extends to a second end portion through a wall portion. The wall portion includes at least one combustion chamber outlet. The fluid delivery nozzle is configured to deliver a non-combustible fluid into the at least one of the plurality of combustor nozzles and the combustion chamber.

### BACKGROUND OF THE INVENTION

The subject matter disclosed herein relates to the art of turbomachines and, more particularly, to a turbomachine combustor assembly.

Many turbomachines include a compressor portion linked to a turbine portion through a common compressor/turbine shaft or rotor and a combustor assembly. The compressor portion guides a compressed airflow through a number of sequential stages toward the combustor assembly. In the combustor assembly, the compressed airflow mixes with a fuel to form a combustible mixture. The combustible mixture is combusted in the combustor assembly to form hot gases. The hot gases are guided to the turbine portion through a transition piece. The hot gases expand through the turbine portion creating work that is output, for example, to power a generator, a pump, or to provide power to a vehicle. In addition to providing compressed air for combustion, a portion of the compressed airflow is passed through the turbine portion for cooling purposes.

The combustor assembly includes a linier portion that defines a combustion chamber. The combustible mixture is combusted in the combustion chamber to form the hot gases. Over time, the liner begins to erode due to exposure to the hot gases. Often times, the erosion begins in high temperature zones located adjacent outlet portions of combustor nozzles. The erosion will have a negative impact on combustor operational life requiring costly and periodic maintenance and replacement in order to maintain turbomachine operation.

### BRIEF DESCRIPTION OF THE INVENTION

According to one aspect of the exemplary embodiment, a turbomachine combustor assembly includes a combustor body, and a combustor liner arranged within the combustor body. The combustor liner defines a combustion chamber having a head end and a discharge end. A plurality of combustor nozzles are arranged in an annular array at the head end of combustion chamber, and a fluid delivery nozzle is arranged substantially centrally within the annular array at the head end of the combustion chamber. The fluid delivery nozzle includes a first end portion that extends to a second end portion through a wall portion. The wall portion includes at least one combustion chamber outlet. The fluid delivery nozzle is configured to deliver a non-combustible fluid into the at least one of the plurality of combustor nozzles.

According to another aspect of the exemplary embodiment, a method of introducing a non-combustible fluid into a turbomachine combustor includes delivering a non-combustible fluid into a fluid delivery nozzle extending into a combustion chamber of the turbomachine combustor, passing a first portion of the non-combustible fluid into at least one of a plurality of combustor nozzles arrayed about the fluid delivery nozzle, and passing a second portion of the non-combustible fluid into the combustion chamber through a combustion chamber outlet formed at an end of the fluid delivery nozzle.

According to yet another aspect of the exemplary embodiment, a turbomachine includes a compressor portion, a turbine portion mechanically linked to the compressor portion, and a combustor assembly fluidly connected to the compressor portion and the turbine portion. The combustor assembly includes a combustor body, and a combustor liner arranged within the combustor body. The combustor liner defines a combustion chamber having a head end and a discharge end. A plurality of combustor nozzles are arranged in an annular array at the head end of combustion chamber, and a fluid delivery nozzle arranged substantially centrally within the annular array at the head end of the combustion chamber. The fluid delivery nozzle includes a first end portion that extends to a second end portion through a wall portion that includes a plurality of combustor nozzle outlets fluidly connected to two adjacent ones of the plurality of combustor nozzles. The wall portion includes a first combustion chamber outlet formed in the second end portion and a second combustion chamber outlet formed in the wall portion adjacent the second end portion. At least one additional non-combustible fluid outlet formed in the liner adjacent the head end of the combustion chamber, the at least one additional non-combustible fluid outlet is configured and disposed to deliver a non-combustible fluid flow between adjacent ones of the plurality of combustor nozzles

These and other advantages and features will become more apparent from the following description taken in conjunction with the drawings.

### BRIEF DESCRIPTION OF DRAWINGS

The subject matter, which is regarded as the invention, is particularly pointed out and distinctly claimed in the claims at the conclusion of the specification. The foregoing and other features, and advantages of the invention are apparent from the following detailed description taken in conjunction with the accompanying drawings in which:

FIG. 1 is a schematic view of a turbomachine including a combustor assembly in accordance with an exemplary embodiment;

FIG. 2 is a partial cross-sectional view of the combustor assembly in accordance with the exemplary embodiment;

FIG. 3 is an end view of the combustor assembly of FIG. 2; and

FIG. 4 is a detail view of a fluid delivery nozzle of the combustor assembly of the exemplary embodiment.

The detailed description explains embodiments of the invention, together with advantages and features, by way of example with reference to the drawings.

### DETAILED DESCRIPTION OF THE INVENTION

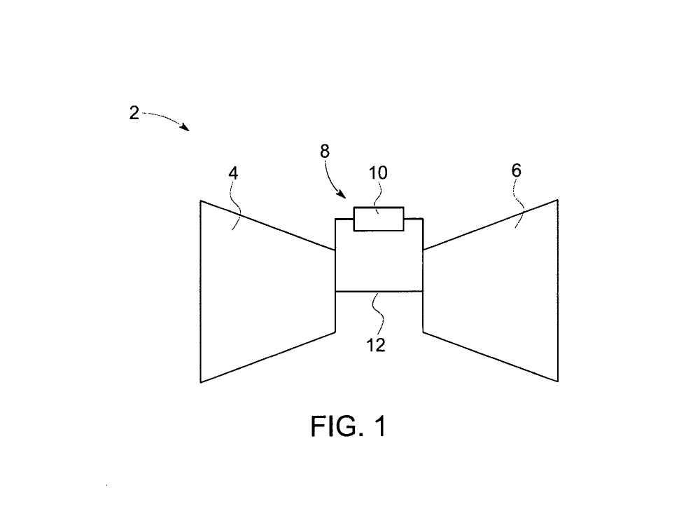

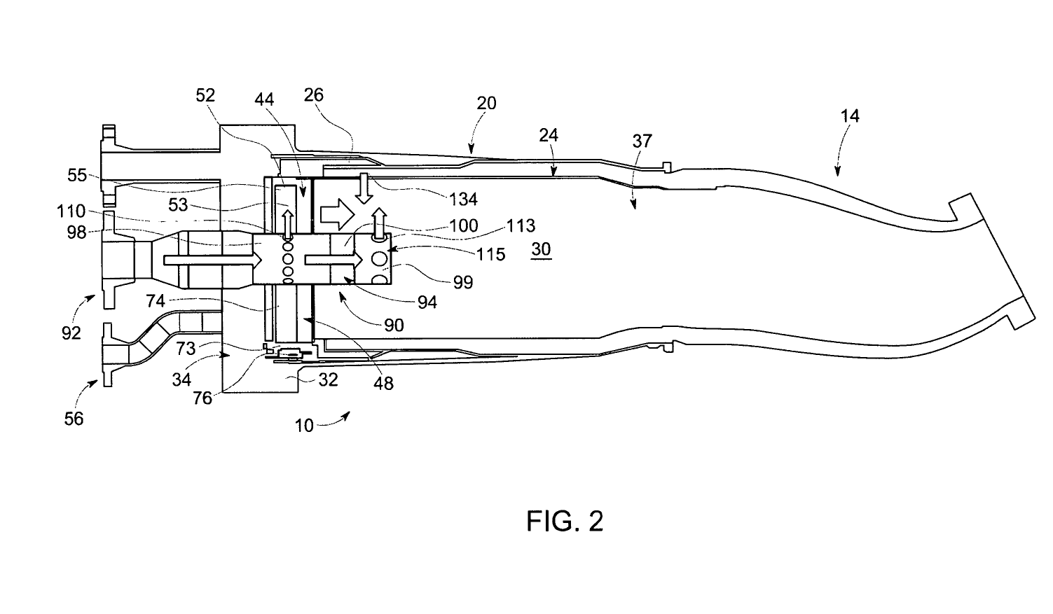

With reference to FIGS. 1 and 2, a turbomachine constructed in accordance with an exemplary embodiment is indicated generally at 2. Turbomachine 2 includes a compressor portion 4 operatively connected to a turbine portion 6. A combustor assembly 8 is fluidly connected to compressor portion 4 and turbine portion 6. Combustor assembly 8 is formed from a plurality of circumferentially spaced combustors, one of which is indicated at 10. Of course it should be understood that combustor assembly 8 could include other arrangements of combustors. Compressor portion 4 is also linked to turbine portion 6 through a common compressor/turbine shaft 12. With this arrangement, compressor portion 4 delivers compressed air to combustor assembly 8. The compressed air mixes with a combustible fluid or fuel to form a combustible mixture. The combustible mixture is combusted in combustor 10 to form products of combustion or hot gases that are delivered to turbine portion 6 through a transition piece 14. The hot gases expand through turbine portion 6 along a gas path (not separately labeled) to power, for example, a generator, a pump, a vehicle or the like (also not shown).

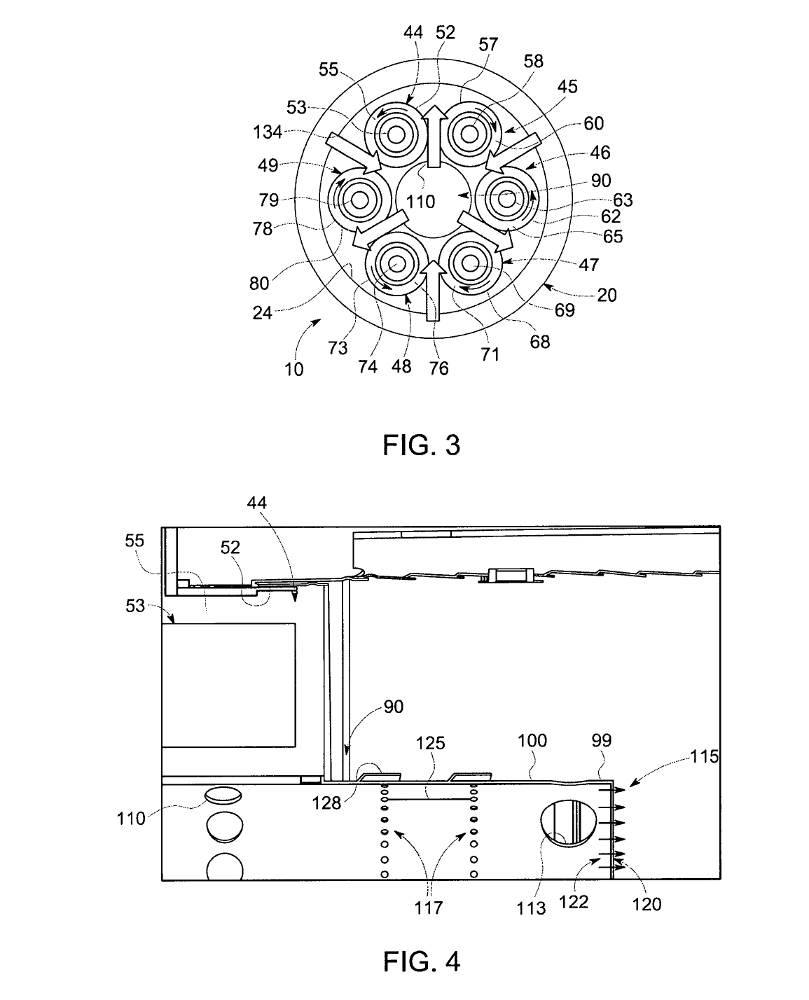

In accordance with an exemplary embodiment, combustor 10 includes a combustor body 20 within which is arranged a combustor liner 24. Combustor liner 24 is spaced from combustor body 20 so as to define a passage 26. Combustor liner 24 defines a combustion chamber 30 having a first or head end 32 provided with a combustor cap 34 and a second or discharge end 37 that is fluidly coupled to transition piece 14. Combustor 10 includes a plurality of combustor nozzles 44-49 (FIG. 3) arranged at head end 32. Combustor nozzles 44-49 are arranged in an annular array having a central region (not separately labeled).

In the exemplary embodiment shown, combustor nozzle 44 includes an outer nozzle portion 52 that surrounds a central discharge portion 53. Outer nozzle portion 52 is spaced from central discharge portion 53 to form a fluid cavity 55. As will be discussed more fully below, fluid cavity 55 receives a non-combustible fluid such as air, steam, and/or an inert gas. The non-combustible fluid mixes with a combustible fluid received through a fuel inlet 56 that extends through combustor cap 34. The combustible fluid passes through central discharge portion 53 and mixes with the non-combustible fluid to form a combustible mixture. The non-combustible fluid also provides cooling to combustor nozzle 44. In a manner similar to that described above, combustion nozzle 45 includes an outer nozzle portion 57, a central discharge portion 58 and a fluid cavity 60; combustor nozzle 46 includes an outer nozzle portion 62, a central discharge portion 63 and a fluid cavity 65; combustor nozzle 47 includes an outer nozzle portion 68, a central discharge portion 69 and a fluid cavity 71; combustor nozzle 48 includes an outer nozzle portion 73, a central discharge portion 74 and a fluid cavity 76; and combustor nozzle 49 includes an outer nozzle portion 78, a central discharge portion 79, and a fluid cavity 80.

In further accordance with the exemplary embodiment, combustor 10 includes a fluid delivery nozzle 90 arranged at head end 32 and positioned within the central region (not separately labeled) of combustor nozzles 44-49. Fluid delivery nozzle 90 is fluidly connected to a non-combustible fluid inlet 92 and includes a nozzle body 94 having a first end portion 98 that extends to a second end portion 99 through a wall portion 100. Fluid delivery nozzle 90 includes a plurality of combustor nozzle outlets, one of which is indicated at 110, formed in wall portion 100. Fluid delivery nozzle 90 also includes a first plurality of combustion chamber outlets, one of which is indicated at 113, a second plurality of combustion chamber outlets, one of which is indicated at 115, and a third plurality of combustion chamber outlets 117 provided in wall potion 100. First plurality of combustion chamber outlets 113 take the form of openings (not separately labeled) formed in wall portion 100. While shown in a single row that extends about nozzle body 94, the number or rows and size of the first plurality of combustion chamber outlets 113 may vary. Second plurality of combustion chamber outlets 115 takes the form of a mini effusion plate 120 having a plurality of openings 122. Third plurality of combustion chamber outlets 117 take the form of openings 125 formed in wall portion 100 between combustor nozzle outlets 110 and first combustion chamber outlets 113. Openings 125 are formed at a pair of flow re-direction elements, one of which is indicated at 128 provided on an outer surface (not separately labeled) of wall portion 100.

With this arrangement, a combustible fluid or fuel is passed through fuel inlet 56 toward combustor nozzles 44-49. The fuel passes from each central discharge portion 53, 58, 63, 69, and 74. At generally the same time, a non-combustible fluid or air is passed through non-combustible fluid inlet 92 toward fluid delivery nozzle 90. The non-combustible fluid flows along nozzle body 94 and passes into each fluid cavity 55, 60, 65, 71, and 76 through combustor nozzle outlets 110. More specifically, combustor nozzle outlets 110 are configured to deliver the non-combustible fluid into two adjacent ones of combustor nozzles 44-49. With this arrangement, the non-combustible fluid enters each fluid cavity 55, 60, 65, 71, and 76 in a particular orientation. For example, the non-combustible fluid entering fluid cavity 55 may flow with a counter-clockwise swirl and non-combustible fluid may enter fluid cavity 60 with a clockwise swirl such as shown in FIG. 3. Thus, swirls in adjacent nozzles flow in opposite directions. The non-combustible fluid mixes with the combustible fluid and passes from each combustor nozzle 44-49 as a combustible mixture that is combusted within combustion chamber 30 to form hot gases. The hot gases flow from combustor 10 into transition piece 14 and on toward a first stage of turbine portion 6.

Additionally, a second portion of the non-combustible fluid entering fluid nozzle 90 passes through first combustion chamber outlets 113, a third portion of the non-combustible fluid passes through second combustion chamber outlets 115, and a fourth portion of the non-combustible fluid passes through third combustion chamber outlets 117. The second portion of non-combustible fluid passing from first combustion chamber outlets 113 flows radially from fluid nozzle 90 into combustion chamber 30 to mix with the combustible mixture to aid in more complete combustion. The third portion of fluid passes through second combustion chamber outlets 115 axially into combustion chamber 30 and provides cooling to mini effusion plate 120. The presence of mini-effusion plate 120 creates a flow restriction that establishes a desired pressure within fluid nozzle 90. Finally, the fourth portion of the non-combustible fluid passes through third combustion chamber outlets 117 and is re-directed by flow re-direction members 118 to form a film cooling flow that flows over the outer surface (not separately labeled) of wall member 100 for cooling purposes.

In addition to the combustible and non-combustible fluids mixing and flowing from combustor nozzles 44-49 and fluid nozzle 90, combustor 10 includes an additional non-combustible fluid outlets 134 134 formed in combustor liner 24. Additional non-combustible fluid outlets 134 guide another non-combustible fluid, such as exhaust gas (EG), steam, or another inert gas into combustion chamber 30 to further enhance combustion and lead to reduced emissions. Additional non-combustible fluid outlets 134 direct the additional non-combustible fluid radially inward toward fluid delivery nozzle 90. More specifically, additional non-combustible fluid outlets 134 are positioned to guide the additional non-combustible fluid between adjacent ones of combustor nozzles 44-49 to mix with and combust with the combustible mixture. The introduction of the additional non-combustible fluid provides cooling to inner surfaces (not separately labeled) of the combustor liner and further leads to lower emissions from turbomachine 2. Cooling the inner surface of the combustion liner leads to an increase in service life of the combustion liner and, by extension, the combustor. That is, by increasing a service life of the combustor, costly maintenance procedures are reduced along with a downtime of the turbomachine. In addition, mixing of combustible and non-combustible fluid provided by the fluid delivery nozzle along with the additional non-combustible fluids leads to more complete burning of various substances such as CO and the like that lead to lower emissions from gas turbomachine 2.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

What is claimed is:

1. A turbomachine combustor assembly comprising:
a combustor body;
a combustor liner arranged within the combustor body, the combustor liner defining a combustion chamber having a head end and a discharge end;
a plurality of combustor nozzles arranged in an annular array at the head end of the combustion chamber;
a fluid delivery nozzle arranged substantially centrally within the annular array at the head end of the combustion chamber, the fluid delivery nozzle including a first end portion that extends to a second end portion through a wall portion, the wall portion including at least one combustion chamber outlet, the fluid delivery nozzle being configured to deliver a non-combustible fluid into the at least one of the plurality of combustor nozzles.

2. The turbomachine combustor according to claim 1, wherein wall portion includes a plurality of combustor nozzle outlets fluidly connected to the plurality of combustor nozzles.

3. The turbomachine combustor assembly according to claim 2, wherein one of the plurality of combustor nozzle outlets is fluidly connected to two adjacent ones of the plurality of combustor nozzles.

4. The turbomachine combustor assembly according to claim 1, wherein the at least one combustion chamber outlet includes a first combustion chamber outlet formed in the second end portion and a second combustion chamber outlet formed in the wall portion adjacent the second end portion.

5. The turbomachine combustor assembly according to claim 4, wherein the first combustion chamber outlet of the fluid delivery nozzle comprises an effusion plate provided at the second end portion, the effusion plate having a plurality of openings that partially obstruct flow passing from the fluid delivery nozzle into the combustion chamber.

6. The turbomachine assembly according to claim 5, wherein the second combustion chamber outlet includes a plurality of openings formed in the wall portion at the second end portion.

7. The turbomachine assembly according to claim 6, wherein the plurality of openings extend circumferentially about the wall portion at the second end portion.

8. The turbomachine combustor assembly according to claim 1, further comprising: at least one additional non-combustible fluid outlet formed in the combustor liner adjacent the head end of the combustion chamber, the at least one additional non-combustible fluid outlet being configured and disposed to deliver additional non-combustible fluid toward the plurality of combustor nozzles.

9. The turbomachine combustor assembly according to claim 8, wherein the additional non-combustible fluid includes one of an exhaust gas and an inert gas.

10. The turbomachine combustor assembly according to claim 1, wherein the non-combustible fluid is air.

11. A method of introducing a non-combustible fluid into a turbomachine combustor, the method comprising:
delivering a non-combustible fluid into a fluid delivery nozzle extending into a combustion chamber of the turbomachine combustor;
passing a first portion of the non-combustible fluid radially outward from the fluid delivery nozzle into at least one of a plurality of combustor nozzles arrayed about the fluid delivery nozzle; and
passing a second portion of the non-combustible fluid into the combustion chamber through a combustion chamber outlet formed at an end of the fluid delivery nozzle.

12. The method of claim 11, wherein passing the first portion of the non-combustible fluid into at least one of the plurality of combustor nozzles includes passing the first portion of the non-combustible fluid through a combustor nozzle outlet formed in a wall of the fluid delivery nozzle into two adjacent ones of the plurality of combustor nozzles.

13. The method of claim 11, wherein passing the first portion of the non-combustible fluid into at least one of the plurality of combustor nozzles includes passing the first portion of the non-combustible fluid into a first combustor nozzle creating a flow about the first combustor nozzle in a first direction and into a second combustor nozzle creating a flow about the second combustor nozzle in a second direction that is opposite to the first direction.

14. The method of claim 11, further comprising: passing a third portion of the non-combustible fluid through another combustion chamber outlet formed at the end of the fluid delivery nozzle, the second portion of the non-combustible fluid passing radially from the fluid delivery nozzle into the combustion chamber and the third portion of the non-combustible fluid passing axially from the fluid delivery nozzle into the combustion chamber.

15. The method of claim 11, further comprising: passing an additional non-combustible fluid through a liner of the turbomachine combustor toward the fluid delivery nozzle.

16. The method of claim 15, wherein passing the additional non-combustible fluid toward the fluid delivery nozzle includes passing one of an exhaust gas and an inert gas between adjacent ones of the plurality of combustor nozzles.

17. A turbomachine comprising:
a compressor portion;
a turbine portion mechanically linked to the compressor portion; and
a combustor assembly fluidly connected to the compressor portion and the turbine portion, the combustor assembly comprising:
a combustor body;
a combustor liner arranged within the combustor body, the combustor liner defining a combustion chamber having a head end and a discharge end;
a plurality of combustor nozzles arranged in an annular array at the head end of the combustion chamber;
a fluid delivery nozzle arranged substantially centrally within the annular array at the head end of the combustion chamber, the fluid delivery nozzle including a first end portion that extends to a second end portion through a wall portion including a plurality of combustor nozzle outlets fluidly connected to two adjacent ones of the plurality of combustor nozzles, the wall portion including a first combustion chamber outlet formed in the second end portion and a second combustion chamber outlet formed in the wall portion adjacent the second end portion; and
at least one additional non-combustible fluid outlet formed in the liner adjacent the head end of the combustion chamber, the at least one additional non-combustible fluid outlet being configured and disposed to deliver a non-combustible fluid flow between adjacent ones of the plurality of combustor nozzles.

18. The turbomachine according to claim 17, wherein the first combustion chamber outlet of the fluid delivery nozzle comprises an effusion plate provided at the second end portion, the effusion plate having a plurality of openings that partially obstruct flow passing from the fluid delivery nozzle into the combustion chamber.

19. The turbomachine according to claim 18, wherein the second combustion chamber outlet includes a plurality of openings formed in the wall portion at the second end portion.

20. The turbomachine according to claim 19, wherein the plurality of openings extend circumferentially about the wall portion at the second end portion.
